(19) United States
(12) Patent Application Publication
(10) Pub. No.: US 2004/0170791 A1
(43) Pub. Date: Sep. 2, 2004

(54) Power steering hose

(76) Inventor: Kazuhito Yanadori, Hiratsuka-shi (JP)

Correspondence Address: RADER FISHMAN & GRAUER PLLC, LION BUILDING, 1233 20TH STREET N.W., SUITE 501, WASHINGTON, DC, 20036, US

(21) Appl. No.: 10/691,583

(22) Filed: Oct. 24, 2003

(30) Foreign Application Priority Data
Oct. 28, 2002 (JP) JP2002-312348

(51) Int. Cl. B32B 1/08

(52) U.S. Cl. 428/36.91

(57) ABSTRACT

Disclosed is a power steering hose, in which at least two reinforcing layers are inserted between inner and outer rubber layers as to sandwich an intermediate rubber layer. Twisted cords of organic fibers constitute the reinforcing layers. The twisted cords have an intermediate elongation at 0.85 cN/dtex of 2.2 to 5%, an elongation at break of 8 to 19%, and a number of twists of 5 to 30/10 cm, respectively.

### BACKGROUND OF THE INVENTION

1. Field of the Invention

The present invention relates to a power steering hose, and more specifically, to a power steering hose capable of achieving both suppression of noise vibration harshness in the passenger compartment and the durability of the hose.

2. Description of the Related Art

The power steering mechanism of a vehicle is structured so that a hydraulic pump, driven by utilizing part of engine power, supplies a steering driving actuator with high-pressure hydraulic fluid through a hose. The hydraulic fluid supply hose (hereinafter, referred to as power steering hose) is constituted by a rubber hose, which is strengthened by a reinforcing layer made of fiber cords, to supply hydraulic fluid steadily.

Since the hydraulic fluid supplied by the hydraulic pump has a pulsating flow, action of the pulsating flow vibrates the power steering hose. Moreover, the vibration of the engine is conveyed to the hose. These vibrations are conveyed to a steering wheel in the passenger compartment through the power steering hose and resonate the steering wheel and produce resonant sound in the passenger compartment. When the resonance of the steering wheel and the resonant sound become large, these give uncomfort to the driver. This is termed noise vibration harshness (hereinafter, referred to as NVH), and a great number of car users demand a measure for reducing NVH.

A measure for reducing NVH has been conventionally proposed in Japanese Patent Laid-Open Publication No. 7(1995)-42879, in which low modulus reinforcing cords with large intermediate elongation are used for the reinforcing layer of the hose. By constituting the reinforcing layer with cords having large intermediate elongation, the expansion of the hose due to the pulsating pressure of hydraulic fluid is increased. Because of the large expansion of the hose, vibration caused by the pulsation of hydraulic fluid and vibration from the engine are absorbed, thereby reducing NVH. However, in this conventional technique, untwisted cords are used as reinforcing cords. Accordingly, the elongation at break increases in proportion with an increase in the intermediate elongation. Thus, there has been a problem that the layer is easily torn by the pulsating effects of hydraulic fluid, and the durability of the hose is reduced.

### SUMMARY OF THE INVENTION

An object of the present invention is to provide a power steering hose capable of achieving both suppression of NVH generated in the passenger compartment and the durability of the hose.

The power steering hose of the present invention for achieving the foregoing object comprises an inner rubber layer, an outer rubber layer, at least two reinforcing layers inserted between the inner and outer rubber layers, and an intermediate rubber layer interposed between the adjacent reinforcing layers. The reinforcing layers are composed of twisted cords of organic fibers which possess an intermediate elongation at 85 cN/dtex of 2.2 to 5.5%, an elongation at break of 8 to 19% and a number of twists of 15 to 30/10 cm, respectively.

By setting the intermediate elongation of the twisted cords, which constitute the reinforcing layers, relatively large in a range from 2.2 to 5.0%, it is possible to increase the expansion of the hose due to the pulsation of hydraulic fluid. This large expansion can reduce the vibration of the hose. Consequently, it is possible to reduce the vibration conveyed to the steering wheel in the passenger compartment as well as resonant sound. Although the intermediate elongation of the twisted cords is large, the elongation at break is set relatively small in a range from 8 to 19%. Thus, the durability of the hose will not be reduced.

In addition, since the reinforcing cords are twisted cords, the durability improves compared with untwisted cords. Moreover, the number of twists is set in a range from 15 to 30/10 cm. Hence, it is possible to adjust the intermediate elongation relatively large in the aforementioned range from 2.2 to 5.0% while the elongation at break is suppressed to a low level within a range from 8 to 19%.

### BRIEF DESCRIPTION OF THE DRAWING

FIG. 1 is a perspective view of a cutaway showing a power steering hose formed in an embodiment of the present invention.

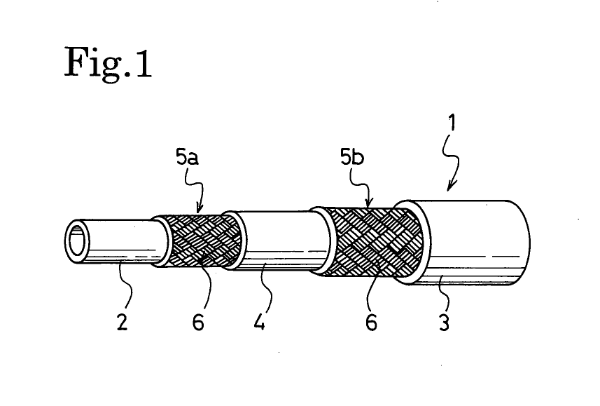

### DESCRIPTION OF THE PREFERRED EMBODIMENTS

In a power steering hose 1 shown in the drawing, reference numerals 2 and 3 denote inner and outer rubber layers, respectively. Two reinforcing layers 5a and 5b are inserted between the inner and outer layers 2 and 3, interposing an intermediate rubber layer 4 therebetween. The reinforcing layers 5a and 5b are formed by cylindrical braids made by twisted cords 6. The twisted cords 6 are made of organic fibers. At least two reinforcing layers provided to the power steering hose 1 may be disposed. Instead of providing two reinforcing layers as in the example shown in the drawing, three or more reinforcing layers may be disposed. In this case, intermediate rubber layers are always provided between the layers.

In the power steering hose of the present invention, a rubber material used for inner, outer and intermediate rubber layers is not particularly limited. However, it is preferable to use chlorosulfonated polyethylene for the outer rubber layer and acrylonitrile-butadiene rubber for the inner and intermediate rubber layers.

Twisted cords made of organic fibers are used for the reinforcing cords constituting the reinforcing layers. Although types of the organic fibers are not particularly limited, it is preferable to use nylon fibers, polyester fibers, polyvinyl alcohol fibers, polyketone fibers or the like. Nylon 66 fibers and nylon 6 fibers are preferred among the nylon fibers. Polyethylene terephthalate and polyethylene naphthalate fibers are preferred among the polyester fibers.

The twisted cords having the intermediate elongation at load of 0.85 cN/dtex of 2.2 to 5.0% as well as the elongation at break of 8 to 19% are used for the reinforcing layers. More preferably, the elongation at break ranges from 13 to 19%.

By setting the intermediate elongation of the twisted cords in a range from 2.2 to 5.0% as described above, it is possible to secure large expansion of the hose due to the pulsation of hydraulic fluid. Moreover, the expansion can efficiently reduce the vibration of the hose caused by the pulsation of hydraulic fluid as well as the vibration conveyed from the engine. Thus, it is possible to improve NVH generated in the passenger compartment due to the vibration of the hose. If the intermediate elongation of the twisted cords is less than 2.2%, the foregoing reduction effects of the vibration cannot be obtained. On the other hand, if the intermediate elongation exceeds 5.0%, the durability of the hose is reduced.

In addition, if the elongation at break of the twisted cords is less than 8%, it is impossible to adjust the intermediate elongation in the foregoing range from 2.2 to 5.0%. When the elongation at break exceeds 19%, the durability of the hose is reduced.

Furthermore, since the reinforcing cords are the twisted cords, the durability can be improved than the case where untwisted cords are used. Additionally, the twisted cords are twisted 15 to 30 times/10 cm. By thus setting the number of twists, it is possible to adjust the intermediate elongation to improve largely while the elongation at break of the twisted cords is suppressed not to be increased largely, when raw organic fiber threads are processed into twisted cords. In other words, when the number of twists is less than 15/10 cm, the elongation at break can be suppressed to a low level. However, the intermediate elongation will not be 2.2% or more. Moreover, when the number of twists is larger than 30/10 cm, the elongation at break is increased, and the durability of the hose is reduced.

In the present invention, the number of twists of the twisted cords indicates the number of twists of the twisted threads when the twisted cords have the single-twist structure. When the twisted cords have the double-twist structure, the number of twists of the twisted cords indicates the number of final twists of the cords formed by giving a plurality of primary twisted threads final twists in the same twist direction of the primary twisted threads.

### EXAMPLES 1 TO 3, COMPARISON EXAMPLES 1 to 6

Nine power steering hoses (Examples 1 to 3 and Comparison Examples 1 to 6) were prepared. All the nine steering hoses have the same hose structure provided with two reinforcing layers as shown in the drawing. In the hoses, the inner and outer diameters were set to 10 mm and 19 mm, respectively. An outer rubber layer was constituted by chlorosulfonated polyethylene, and inner and intermediate rubber layers were constituted by acrylonitrile-butadiene rubber. The reinforcing layers were constituted by braids (braid angle of 51°) made of nylon 66 cords of 940 dtex/3. As shown in Table, the nine power steering hose have different twist structures of the nylon 66 cords, the number of twists (times/10 cm), and intermediate elongation (%) at 0.85 cN/dtex and elongation (%) at break.

Sound vibration characteristics (NVH characteristics) and the hose durability of these nine power steering hoses were measured by the undermentioned examination method. The results are listed on Table 1.

[Sound Vibration Characteristics (NVH Characteristics)]

The test hoses with a length of 400 mm were filled with hydraulic fluid, and pulsating pressure of 5±0.1 MPa was added thereto at the temperature of 50° C. First resonance obtained when the frequency of the pulsating pressure was changed was measured. In the evaluation of the sound vibration characteristics, the hoses with the measured first resonance of 130 Hz or less are given mark “A”, indicating that the hoses do not cause uncomfort and are satisfactory products. The hoses with the first resonance of 130 Hz or more are given mark “C”, indicating that the hoses give uncomfort and are unsatisfactory products.

[The Durability of Hose]

The test hoses with a length of 400 mm were filled with hydraulic fluid, and impact pressure was repeatedly given thereto under the condition where the temperature is 150° C. and the pressure is 8 MPa until the hoses broke. The number of times that the impact pressure is given until the hoses broke was measured. In the evaluation of the hose durability, the examination was terminated when the number of time that the impact pressure was given exceeded 400,000 times. Those hoses are given mark “A”, indicating that the hoses are satisfactory products. Hoses broken with less than 400,000 times are given mark “C”, indicating that the hoses are unsatisfactory products, and mark “B”, if the hoses are permissible products.

TABLE 1

| | | | | | | Hose |
|---|---|---|---|---|---|---|
| | | | | | | Durability |
| | | Number of | Intermediate | Elongation | Sound Vibration | (Ten |
| | Cord | Twists | Elongation | at Break | Characteristics | Thousand |
| | Structure | (Times/10 cm) | (%) | (%) | (HZ) | Times) |
| Example 1 | Single | 20 | 2.5 | 15.9 | 127(A) | 40(A) |
| | Twist | | | | | |
| Example 2 | Single | 20 | 5.0 | 18.5 | 120(A) | 38(B) |
| | Twist | | | | | |
| Example 3 | Double | 20 | 3.0 | 17.1 | 122(A) | 40(A) |
| | Twist | | | | | |
| Comparison | Single | 20 | 2.0 | 15.2 | 136(C) | 40(A) |
| Example 1 | Twist | | | | | |
| Comparison | Single | 20 | 5.2 | 20.2 | 119(A) | 30(C) |
| Example 2 | Twist | | | | | |
| Comparison | Single | 10 | 2.0 | 18.5 | 133(C) | 40(A) |
| Example 3 | Twist | | | | | |
| Comparison | Single | 10 | 2.2 | 20.0 | 128(A) | 25(C) |
| Example 4 | Twist | | | | | |
| Comparison | Untwist | 0 | 1.7 | 18.6 | 138(C) | 40(A) |
| Example 5 | | | | | | |
| Comparison | Untwist | 0 | 2.2 | 21.0 | 128(A) | 30(C) |
| Example 6 | | | | | | |

What is claimed is:

1. A power steering hose comprising an inner rubber layer, an outer rubber layer, at least two reinforcing layers inserted between the inner and outer rubber layers, and an intermediate rubber layer interposed between the adjacent reinforcing layers, the reinforcing layers composed of twisted cords of organic fibers, wherein the twisted cords have an intermediate elongation at 0.85 cN/dtex of 2.2 to 5.0%, an elongation at break of 8 to 19% andanumber of twists of 15 to 30/10 cm, respectively.

2. The power steering hose according to claim 1, wherein the elongation at break of the twisted cords ranges from 13 to 19%.

3. The power steering hose according to claim 1, wherein the organic fibers are one type of fibers selected from the group consisting of nylon fibers, polyester fibers, polyvinyl alcohol fibers and polyketone fibers.

4. The power steering hose according to any one of claims 1, 2 and 3, wherein the twisted cords have a single-twist structure.

5. The power steering hose according to any one of claims 1, 2 and 3, wherein the twisted cords have a double-twist structure in which a plurality of primary twisted cords are twisted together with final twists in a same twist direction of the primary twisted cords.

6. The power steering hose according to claim 4, wherein the reinforcing layers are formed by braids of the twisted cords.

7. The power steering hose according to claim 5, wherein the reinforcing layers are formed by braids of the twisted cords.
